(19) United States
(12) Patent Application Publication
(10) Pub. No.: US 2002/0146138 A1
(43) Pub. Date: Oct. 10, 2002

(54) Ultrasound based parametric multi-path loudspeaker system

(76) Inventors: Guido Kolano, Salach (DE); Klaus Linhard, Schelklingen (DE)

Correspondence Address: Stephan A. Pendorf, Pendorf & Cutliff, P.O. Box 20445, Tampa, FL, 33622-0445, US

(21) Appl. No.: 10/118,631

(22) Filed: Apr. 8, 2002

(30) Foreign Application Priority Data
Apr. 7, 2001 (DE) 101 17 528.0-35

(51) Int. Cl. H04B 3/00; H04B 5/00

(52) U.S. Cl. 381/77; 381/79

(57) ABSTRACT

An arrangement of parametric loudspeakers is described, in which the totality of the transducers is subdivided into groups, wherein each group is controlled by at least one modulator associated therewith, so that a parametric multi-path loudspeaker system results. Thereby it is made possible, that for each of the paths the transducer operates in the optimal resonance range.

### BACKGROUND OF THE INVENTION

1. Field of the Invention

The invention concerns a process for controlling a parametric loudspeaker system, comprised of (a) one or more transducer elements for ultrasound, which are adapted for producing a AM-signal by appropriate or suitable controlling or driving, which upon spreading out in a gaseous medium produce an audible signal by self demodulation, (b) one or more amplifiers associated with these transducer elements, and (c) one or more therewith associated modulators, which receive a signal from a source as an input signal, and a device suitable for carrying out the process.

2. Description of the Related Art

An emission of directional sound waves requires a sound transducer with a geometric size in the range of multiple wavelengths. In place of a single transducer it is also possible to employ multiple transducers in order to produce the large geometric measurement. An arrangement of multiple transducers is referred to as an array. The individual transducers can additionally have an upstream signal processor in order to increase the directionality of the array.

In order to produce a strong directionality with small transducer size a modulation technique can be employed in order to couple a low frequency useful signal (audio signal) with a high frequency carrier signal. It is the wavelength of the higher frequency carrier signal that is primarily determinative of directionality. A parameter of the carrier signal is controlled by the useful signal. From this, the term parametric transducer or parametric array is derived.

### SUMMARY OF THE INVENTION

The present invention is concerned with a parametric loudspeaker which employs ultrasound as the carrier signal. The basic physical experiments can be traced back to the German physicist Helmholz in the 19^{th} century. A useful loudspeaker system is described by Yoneyama, et al.: “The Audio Spotlight: An Application of Nonlinear Interaction of Sound Waves to a new Type of Loudspeaker Design”; J. Acoust. Soc. Am., Vol. 73, pp. 1532-1536. Reports thereof were made in the subsequent years in further publications of Berktay, Blackstock, Pompei and others.

If ultrasound is emitted at very high levels, the air becomes a nonlinear medium, which causes a self-demodulation of the modulated ultrasound on the basis of the nonlinearity. Therewith, the modulated signal becomes audible. The ultrasound itself remains inaudible.

In a subsequently published patent application with the same application date as the present application, a parametric loudspeaker system is described, which is based upon the FM-modulation of an ultrasound carrier. Systems which are known in the state of the art work with AM-modulation. The FM-modulation however brings about a good adaptation or conformance to the resonant transducers, such as the conventionally employed piezo-ceramic transducers. The resonance edge or side lobe of the transducer is used for FM/AM-conversion. The FM-resonance-principle can also be extended to resonance free or resonance poor transducers such as for example electrostatic transducers.

From WO 01/08449 A1 a process for reproducing audio waves using ultrasound loudspeakers is known, wherein the audio signal to be reproduced is coupled with a carrier signal in the ultrasound frequency range by a side-band amplitude modulation. For increasing the wave pressure it is proposed therein to employ a greater number of transducers. In order to improve the reproducibility of deep notes, it is indicated, without explanation, that in place of a tight clustering of the transducers, these should be arranged in a ring.

It is the task of the invention to find a new process for controlling a parametric loudspeaker system, comprised of (a) one or more transducer elements for ultrasound, which are adapted for producing a AM-signal by appropriate or suitable controlling or driving, which upon spreading out in a gaseous medium produce an audible signal by self demodulation, (b) one or more amplifiers associated with these transducer elements, and (c) one or more therewith associated modulators, which receive a signal from a source as an input signal, and a device suitable for carrying out the process.

In particularly preferred manner, in the inventive process and the inventive device for controlling a parametric loudspeaker system are comprised of one of more transducer elements for ultrasound, the transducer elements in their totality are subdivided into groups, wherein each group is controlled by at least one associated modulator. In this manner there results a parametric multi-path loudspeaker system.

Certainly, the person of ordinary skill in the art of audio signal processing is familiar with multi-path loudspeakers for. audio reproduction. These loudspeaker systems are a useful means for the emission of broadband audio signals. Herein however the emission of the audio signals occurs directly in the respective desired audible frequency range. None of the devices known in the state of the art provides suggestion to the person of ordinary skill in the art as to how to construct a corresponding parametric loudspeaker system. This above all because of the special characteristics of the parametric loudspeaker, which is based on its directionality. It is precisely this directionality which is desired to be avoided in the known systems comprising the state of the art. For this reason, for the wide angle emission of high frequency audio sounds special wide angled spherical surface loudspeakers are employed. Further, the loudspeaker systems known from the state of the art do not suggest any special arrangement of the individual groups of loudspeakers; to the contrary the most diverse arrangements of high, medium and base loudspeakers are shown. With multi-path systems on the basis of parametric loudspeakers there are however, as discussed below, depending upon frequency range, special arrangements (denser or more spread out) of the transducers to be considered. With parametric loudspeaker systems, in contrast to the devices known from the state of the art, a frequency range specific optimization of the transducer arrangement should occur. With the known automobile loudspeakers there occurs essentially only an optimization in reference to the totality of all employed loudspeakers in order to produce a better interior sound.

### BRIEF DESCRIPTION OF THE DRAWINGS

On the basis of illustrative examples and with the aid of the figures the subject matter of the invention will now be described in greater detail below.

FIG. 1 shows a multi-path loudspeaker system on the basis of parametric loudspeakers.

FIG. 2 shows an advantageous arrangement of the transducers within a multi-path loudspeaker system.

### DETAILED DESCRIPTION OF THE INVENTION

When employing multiple transducers there supplementally results an array effect, that is, a directionality of an individual transducer is superimposed by the directionality effect which is produced by the array, so that overall a stronger directionality results. The determinative aspect of the directionality effect is primarily the ultrasound which is emitted by the transducers. The directionality resulting for the audible audio waves can be deduced by consideration of a model. In accordance therewith the process of the self-demodulation is represented by very many virtual loudspeakers, which are situated within a three-dimensional air space which is brought into excitation by the ultrasound. The superimposition of these virtual sources produces the desired audio directional effect.

The production of an audible sound excitation is based upon the self demodulation at high sound wave pressures. A generating curve or envelope function must be present, which can then be made audible again by the spreading out in the nonlinear medium. This is similar to producing the generating curve with the desired AM-modulation.

In a particularly preferred manner the present invention employs frequency modulation (FM) as the modulation process. For this reason the generating curve of the signal to be emitted by the transducers must be produced in a different mode and manner, since the physical principle of the self-demodulation known in the state of the art is to be taken advantage of.

In the AM-modulation with resonant transducers as known in the state of the art, such as for example conventional piezo transducers, the carrier (conventionally at the maximum of the transducer function) and the two side bands are transformed with quite different transmission values of the transducer function. That means, the carrier and the deep audio frequencies are more strongly transmitted than the higher audio frequencies which lie far to the right or far to the left in the two side bands. This results therein, that the degree of modulation changes, in the manner, that high audio frequencies are less modulated and thus less strongly produced. Depending upon desired characteristics, corrections of the hereby produced audio signal or the modulated signal may be necessary. The FM-principle has the primary advantage, that this frequency dependency attributable to the resonance flank does not occur. The resonance flank is necessary in the FM-principle (and is not an interference factor). The emitted energy with these ultrasound transducers depends in part very strongly upon the employed frequency. Herein there are one or more frequencies, for which the emission assumes relatively high values (resonance points). In the vicinity of these resonance points the emitted power drops more or less strongly. This behavior can be utilized for the production of audible sounds. Herein the audio pressure of an arrangement of transducer elements can be achieved on the one hand by enlarging the individual elements, as well as by increasing the total number of the transducer elements.

On the basis of an FM-modulated signal, which is supplied to the arrangement of ultrasound transducers in the following, the inventive subject matter will be described in greater detail. The principle can of course also be employed in advantageous manner with AM-modulated input signals; however, disadvantages can be expected to be associated with the use of high audio frequencies with resonant transducers in the case of AM-modulated input signals, in comparison to the use of an FM-modulated signal, by means of which the transducers can be controlled independent of frequency.

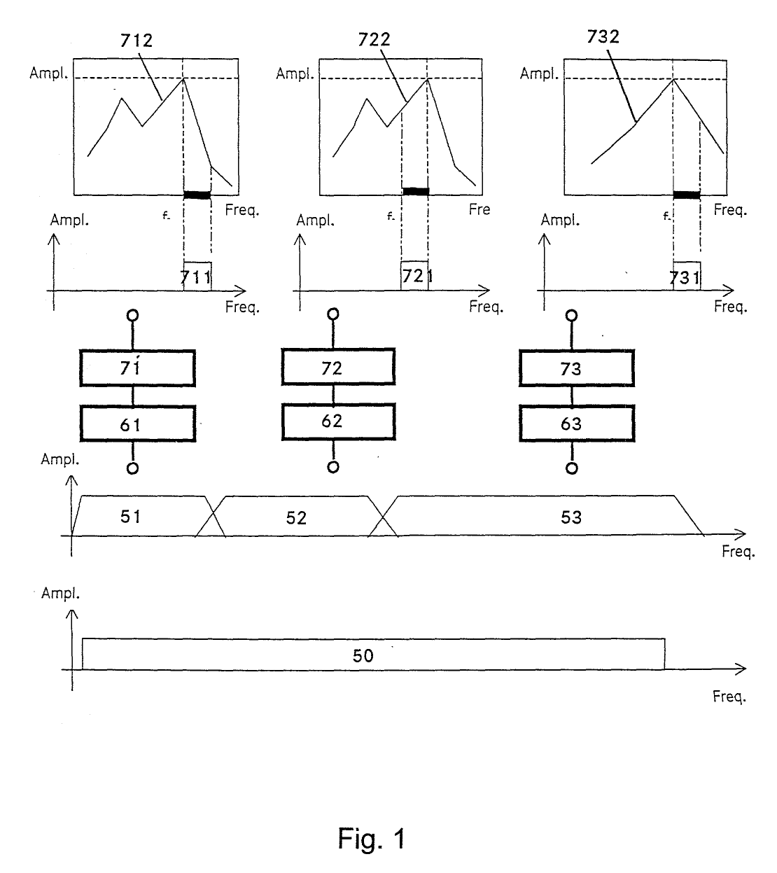

In FIG. 1 a multi-path loudspeaker system is shown. The audio-signal 50 is divided by a frequency separation into multiple paths. For example, three paths can be arranged: for the deep frequencies 51, for the intermediate frequencies 52 and for the higher frequencies 53. The signals from each of these “paths” are input to the corresponding FM-modulator (61, 62 or 63), an amplifier step (71, 72 or 73) and an associated transducer. For the individual paths different transducers with varying transducer characteristic lines (712, 722 or 732) can be employed, for example for the deeper frequencies as a rule transducers with higher power are employed.

It is particularly advantageous that the multi-path system with FM-modulation can be tuned or designed in each of the paths to the resonance frequency f₀ of the respective transducers, corresponding to (71, 72 or 73), whereby a good efficiency results. The transducers thus work under the best possible conditions. In addition, with the selection of a transducer type for each path the possibility results to optimally fit the band breadths and power of the transducers to the signal of the respective signal path.

In advantageous manner the inventive multi-path system can be so arranged or designed, that a power fit of the transducer occurs by the employed frequency range, in such a manner, that the selection of the transducer of a group of transducers is matched to the power required in this frequency band. It is additionally also advantageous for each of the individual groups of transducers to optimize the respective directionality of the loudspeaker system, wherein the selection of each transducer of a group of transducers occurs on the basis of the directionality of the individual transducers in the respective band.

It is quite particularly advantageous for the inventive multi-path system when the directionality of the loudspeaker system is optimized respectively for each of the individuals of the groups of transducers, in that the individual groups of transducers are arranged differently geometrically in particular depending upon the frequency band of the input signal of the modulator assigned to them.

It has been discovered by experimentation, that for the production of deep audio frequencies a larger air column must be excited (transducers outside on the array) than for high audio frequencies (transducers interior to the array). By the geometric arrangement and distribution of the transducers in a multi-path system an optimization in this respect can be achieved.

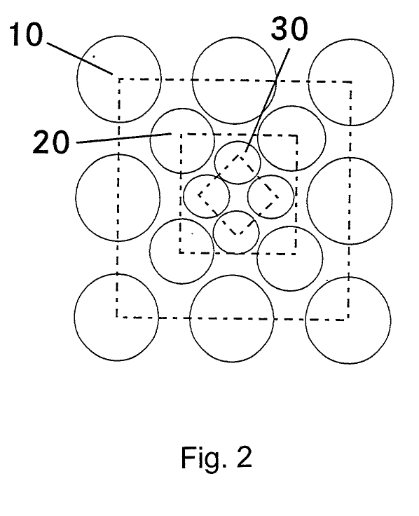

FIG. 2 shows an advantageous embodiment wherein 8 transducers are arranged in an outer square 10. The arrangement of the transducers in the shape of a square is here only for purposes of example. A further square 20 with four transducers occurs further inwardly and finally there is a diagonally arranged square 30 of four transducers in the inside of the array. The total arrangement represents a 3-path-system. Preferably, high power transducers are arranged in the outer quadrant for the base, then further inward the transducers for the intermediate sounds and finally in the center the transducers for the higher sounds are arranged.

Of course the present invention is not limited to the inventive arrangement of the transducers as shown in FIG. 2. The person of ordinary skill in this art having the above description is naturally able, depending upon the employment and the geometric arrangement of the place of installation and the environment of use, to design a multi-path loudspeaker in advantageous manner taking into consideration the herein explained principles and basic concepts.

What is claimed is:

1. Process for controlling a parametric loudspeaker system, comprised of
one or more transducer elements for ultrasound, which are adapted for producing a AM-signal by appropriate or suitable controlling or driving, which upon spreading out in a gaseous medium produce an audible signal by self demodulation,
one or more amplifiers associated with these transducer elements
and one or more therewith associated modulators, which receive a signal from a source as an input signal, thereby characterized, that the totality of the transducers is divided into groups, wherein each group is controlled by at least one associated modulator, to thereby produce a parametric multi-path loudspeaker system.

2. Process according to claim 1, thereby characterized, that the individual modulators are respectively supplied by one signal from a multi-path division of the input signal, wherein in the framework of the multi-path division a frequency-based band separation of the input signal for the modulators is undertaken.

3. Process according to one of claims 1 through 2, thereby characterized, that in the case that the transducers, which are divided into multiple groups, group-wise exhibit respective different characteristic lines, the groups are respectively associated with different modulators.

4. Process according to one of claims 1 through 3, thereby characterized, that a power matching of the transducers occurs via the employed frequency range, in that manner, that the selection of the transducers of a group of transducers is matched to the power requirement for the frequency band.

5. Process according to one of claims 1 through 4, thereby characterized, that the respective directional effect of the loudspeaker system is optimized for each individual of the group of transducers, in that the selection of the individual transducers of a group of transducers occurs on the basis of the directionality of the individual transducers in the respective frequency band.

6. Process according to one of claims 1 through 5, thereby characterized, that for each individual of the groups of transducers the respective directional effect of the loudspeaker system is optimized, in that the individual groups of transducers, in particular depending upon the frequency band of the input signal of the modulator assigned to them, are arranged differently geometry.

7. Device for controlling a parametric loudspeaker system, comprised of
one or more transducer elements for ultrasound, which are adapted for producing a AM-signal by appropriate or suitable controlling or driving, which upon spreading out in a gaseous medium produce an audible signal by self demodulation,
one or more amplifiers associated with these transducer elements
and one or more therewith associated modulators, which receive a signal from a source as an input signal, thereby characterized, that a means is provided for dividing the totality of the transducers into groups, wherein each group is controlled by at least one associated modulator, producing a parametric multi-path loudspeaker system.

8. Device according to claim 7, thereby characterized, that a means is provided for a multi-path division of the input signal, wherein in the framework of the multi-path division a frequency-based band separation of the input signal for the modulators is undertaken.

9. Device according to one of claims 7 through 8, thereby characterized, that in the case that the transducers, which are divided into multiple groups, group-wise exhibit respective different characteristic lines, the groups are respectively associated with different modulators.

10. Device according to one of claims 7 through 9, thereby characterized, that a power matching of the transducers occurs via the employed frequency range, in that manner, that the selection of the transducers of a group of transducers is matched to the power requirement for the frequency band.

11. Device according to one of claims 7 through 10, thereby characterized, that the respective directional effect of the loudspeaker system is optimized for each individual of the group of transducers, in that the selection of the individual transducers of a group of transducers occurs on the basis of the directionality of the individual transducers in the respective frequency band.

12. Device according to one of claims 7 through 11, thereby characterized, that for each individual of the groups of transducers the respective directional effect of the loudspeaker system is optimized, in that the individual groups of transducers, in particular depending upon the frequency band of the input signal of the modulator assigned to them, are arranged differently geometry.

13. Device according to one of claims 7 through 12, thereby characterized, that the transducers are so arranged, that the transducers which are associated with the lower frequencies of the input signal are positioned at the outer area of the device and that the transducers which are associated with the high frequencies of the input signal are positioned at the inner area of the device.

14. Device according to one of claims 7 through 13, thereby characterized, that the transducers which are associated with the high frequencies of the input signal are tightly clustered and that the transducers which are associated with the lower frequencies of the input signal are relatively more spread out.

14. Device according to one of claims 7 through 14, thereby characterized, that the modulators are FM modulators.
